(19) United States
(12) Patent Application Publication
(10) Pub. No.: US 2015/0117763 A1
(43) Pub. Date: Apr. 30, 2015

(54) IMAGE QUALITY MEASUREMENT BASED ON LOCAL AMPLITUDE AND PHASE SPECTRA

(71) Applicants: Fan Zhang, Beijing (CN); Zhibo Chen, Beijing (CN); Wenfei Jiang, Beijing (CN)

(72) Inventors: Fan Zhang, Beijing (CN); Zhibo Chen, Beijing (CN); Wenfei Jiang, Beijing (CN)

(73) Assignee: THOMSON LICENSING, Issy de Moulineaux (FR)

(21) Appl. No.: 14/394,626

(22) PCT Filed: May 31, 2012
(86) PCT No.: PCT/CN2012/076338

§ 371 Date: Oct. 15, 2014

(51) Int. Cl. G06T 7/00; G06K 9/66; G06T 3/40

(52) U.S. Cl. CPC G06T 7/0002; G06T 3/4084; G06K 9/66; G06T 2207/20048
USPC 382/159; 382/173

(57) ABSTRACT

A method and system for determining a quality metric score for image processing are described including accepting a reference image, performing a pyramid transformation on the accepted reference image to produce a predetermined number of scales, applying image division to each scale to produce reference image patches, accepting a distorted image, performing a pyramid transformation on the accepted distorted image to produce the predetermined number of scales, applying image division to each scale to produce distorted image patches, performing a local distortion calculation for corresponding reference and distorted image patches, summing local distortion calculation results for image patch pairs, multiplying results of the summation operation by a positive weight for each scale, summing the results of the multiplication operation and applying a sigmoid function to results of the second summation operation to produce the quality metric score.

### FIELD OF THE INVENTION

The present invention relates to image processing and, in particular, to the efficient solution of quality aware optimization problems.

### BACKGROUND OF THE INVENTION

Measuring image quality is widely applied to perceptual image processing, e.g. perceptual coding, tone mapping, restoration, watermarking, etc. Visual quality metrics include full-reference metrics and no-reference metrics, according to the availability of reference image/video. For full-reference quality metrics, the image difference between the reference and the impaired image/video may be the key factor to the visual quality.

Perceptual image processing often exploits aspects of the human visual system (HVS) and seeks a tradeoff between a good image quality and an effective particular target of the processing. For example, the perceptual coding looks for a tradeoff between a low distortion and an efficient bit rate, while the perceptual watermarking pursues a tradeoff between an invisible and robust watermark.

A well-defined objective function is usually available for the particular target (e.g. how to measure bit rate or the watermark robustness), but there is a lack of a concise yet accurate objective function for the image quality. Mean square error (MSE) or peak signal-to-noise ratio (PSNR) is simple but not sufficiently accurate. Other existing image quality metrics may be accurate enough but complex for an optimization problem. For example, perceptual image processing by optimizing structural similarity index (SSIM) is nontrivial work. No literature has reported how to guide image processing by optimizing Visual Information Fidelity (VIF) or Feature SIMilarity index (FSIM).

The human ability to perceive images emerges in a sequence of brain areas known as the ventral stream, beginning with the primary visual cortex (V1). The first stage of processing of visual stimuli is performed by simple and complex cells in the V1, where complex cell's response is often modeled by the magnitudes of multiple simple cells' responses. The second stage of the ventral system may be modeled by computing products between pairs of V1 responses (both simple and complex) and averaging these products over local regions. Simple cells respond selectively to bars and edges at a particular location, of a particular orientation, and with particular bands of spatial frequency. Complex cells differ from simple cells by showing relative invariance to a phase shift of the stimulus (i.e. a small translation vertical to the orientation of the stimulus). This phase-invariant feature is important for recognition, which has to cope with small local deformations.

Frequency-based representation of images furthered understanding about the collaborative functionalities of simple and complex cells. Since complex cells' responses encode the magnitude information and largely omit the phases, it is of particular interest how the identity (or recognizability) of images is attributable to phase spectra versus power spectra. To answer this question, prior art researchers either reconstructed image from phase only or swapped the power spectra from another image, and then examined the subjective resemblance of the obtained image to the original image. Both the phase-only reconstruction and the power spectra swapping preserved the essential image identity. This is usually interpreted as phases containing more information than the global power spectra, also termed as “phase dominance”. The paradox, between the phase-invariant preference by neurons and the phase dominance in images, suggests that the local phase information is encoded and fused with the phase-invariant neural responses for the later processing of ventral stream.

Recently, the problem of “phase vs. amplitude” has been delved into more deeply, for example, investigating the human ability to detect degradations in the phase and amplitude or to classify degraded images. Such degradations may include low-pass filtering to remove the high-frequency, phase-only reconstruction by equalizing the power spectra; additive random noise to the phase spectra; the synthesized image matching of the simulated neural responses of the original image, etc. The theoretical analysis on the MSE (mean squared error) in the degraded image attributable to the amplitude error and the phase error respectively is given in one prior art study. Another interesting prior art method is to quantitatively estimate the contribution of phase and amplitude in terms of the “entropy measures”. The more thoughtful prior art viewpoints include: it is true for natural images that the global power spectra are not as diversified as the phases and thereby contain less “entropy”, nevertheless power spectra convey important clues about images; and meanwhile the spatial scale of the image is a key factor affecting the relative importance between phase and amplitude. For small image patches the perceived image structure can be well described by the local power spectra; for larger image patches the phase dominates.

Subjective image quality assessment in response to the amplitude and phase error has not been reported for a general scope of image distortions, except for certain particular distortions like blur. If quality assessment by the human visual system can be modeled as a neural network with the input of images and the output of quality opinions, subjectively-rated image quality databases provide ample input-output pairs, via which such a neural network can learn.

### SUMMARY OF THE INVENTION

The present invention provides a concise full-reference image quality metric, which ensures an efficient solution to quality-aware optimization problems, such as high dynamic range imaging, compressive sensing, coding, perceptual watermarking, optical character recognition, iris recognition, fingerprinting, medical image processing etc.

FIG. 1A is a schematic diagram showing the application of the quality metric of the present invention to a quality-aware image processing system. The present invention may be used in a variety of image processing systems that require automatic (objective) image quality assessment, which is a fundamental function required by many quality-aware (or perceptual) image processing systems or applications. In FIG. 1A, an image processing system that requires an automatic image quality assessment accepts images and produces a result that is input to the quality metric of the present invention. The quality metric determines a quality score using the reference and the distorted or processed images and provides the score to a quality-aware control module for feedback to the image processing system.

In the frequency-based representation of images, phase and amplitude convey complementary information. Phase has been regarded as dominating the image appearance, however power (amplitude) spectra have recently been found useful for image classification. In the primary visual cortex (V1), simple cells are sensitive to and thereby encode the phase of visual stimuli, while complex cells, as are the majority of V1, show phase-invariance and encode the energy (magnitude) of simple cells' spikes. Herein, an attempt is made to quantitatively exploit the relative importance of the phase and amplitude to visual perception, by learning from subjective image quality assessment. An image quality metric is proposed based on the weighted combination of the phase and amplitude errors, and the weights are determined so as to maximize the prediction accuracy of the metric on subjectively-rated databases. The results confirm that: 1) both the phase and the amplitude are necessary for image quality assessment; 2) the amplitude becomes more important at the finest image scale while the phase is more important at the coarser scale.

The present invention includes an image quality metric designed as a function of the simulated amplitude and phase error. The metric parameters were optimized so as to match the predicted quality of the subjective opinions. The quality metric of the present invention is denoted Product of the simulated Amplitude and Phase error or PAP metric. The PAP metric is concise, yet comparably accurate to the state-of-the-art image quality metrics. The optimized parameters support the viewpoint that: the amplitude plays a more important role at the finest image scale while the influence of the phase becomes more significant at the coarser scale.

The image quality metric of the present invention was inspired by a neuroscience model of the primary visual cortex (V1), termed independent subspace analysis (ISA) [5], and predicts image quality by two factors including the local amplitude spectrum and the local phase spectrum of images.

After training on a large number of natural image patches by ISA, a set of orthogonal image bases was obtained. The orthogonal image bases were organized into dozens of subgroups during ISA. The projection of an image patch to one of the bases (i.e. an ISA-transform-coefficient of the image patch) can mimic the response of a simple neuron of V1 to the stimuli of the image patch. The sum of the squared projections of an image patch to all bases of a subgroup can mimic the response of the complex neuron of V1.

Simple neurons are sensitive to the orientation, spatial frequency and the phase (i.e. location) of the visual stimuli. Their receptive fields are often captured by a family of Gabor functions. Research has shown that simple cell of the V1 of mammalian brains can be modeled by Gabor functions. Thus, image analysis by Gabor functions is similar to perception in the human visual system. Complex neurons are also sensitive to the orientation, spatial frequency of the visual stimuli, but insensitive to their phase. ISA bases are in-line with the above knowledge: each ISA basis looks like a Gabor function with a special orientation, spatial frequency and phase. The bases in a subgroup share the similar orientation and spatial frequency but vary in phase. Thus, the sum of the squared projections of a Gabor-like stimulus to all bases of a subgroup keeps nearly constant when the phase of the Gabor-like stimulus varies slightly.

Projecting an image patch to a subgroup of ISA bases, an ISA-transform-coefficient vector is obtained. The amplitude of the vector is defined as the root mean square of all the ISA-transform-coefficients associated with the subgroup. For the reference and the distorted image patches, there are two ISA-transform-coefficient vectors respectively. The amplitude difference is the difference between their amplitudes, and the phase difference is defined as the angle between the two vectors.

The local distortion is defined as the product of a power function of the amplitude difference and a power function of the phase difference. The global distortion is the sum of all local distortions.

To simulate the selectivity in spatial-frequency of neurons, the global image distortion is computed at multiple spatial scales via a classic image pyramid transform. The total distortion is the sum of the global distortion at all scales.

Finally, a sigmoid function is used, e.g. log-logistic function, to map the total distortion to a quality score.

A method and system for determining a quality metric score for image processing are described including accepting a reference image, performing a pyramid transformation on the accepted reference image to produce a predetermined number of scales, applying image division to each scale to produce reference image patches, accepting a distorted image, performing a pyramid transformation on the accepted distorted image to produce the predetermined number of scales, applying image division to each scale to produce distorted image patches, performing a local distortion calculation for corresponding reference and distorted image patches, summing local distortion calculation results for image patch pairs, multiplying results of the summation operation by a positive weight for each scale, summing the results of the multiplication operation and applying a sigmoid function to results of the second summation operation to produce the quality metric score.

### BRIEF DESCRIPTION OF THE DRAWINGS

The present invention is best understood from the following detailed description when read in conjunction with the accompanying drawings. The drawings include the following figures briefly described below:

FIG. 1A is a schematic diagram showing the application of the quality metric of the present invention to a quality-aware image processing system.

FIG. 1B is a block diagram of an exemplary embodiment of the local distortion.

FIG. 2 is a block diagram of an exemplary embodiment of the total distortion.

FIG. 3 is a set of plots of DMOS vs. predicted scores of the quality metric of the present invention on various datasets.

FIG. 4 is a flowchart of an exemplary embodiment of the local distortion computation of the quality metric of the present invention (PAP metric).

FIG. 5 is a flowchart of an exemplary embodiment for determining the score of the quality metric of the present invention (PAP metric).

FIG. 6 (a) is an iso-distance map of (1, 0) using the Equation (6) metric.

FIG. 6 (b) is an iso-distance map using the MSE.

### DETAILED DESCRIPTION OF THE PREFERRED EMBODIMENTS

ISA bases are pre-learned in an offline manner, independent of the images, the quality of which is to be predicted. In an exemplary embodiment, 8×8 ISA is performed, and 14 subgroups are obtained. Each subgroup contains four bases. There are a total of 56 bases. The bases define an orthogonal (incomplete) transform. ISA transform is a linear matrix computation like a 2-dimensional DCT. Therefore, each 8×8 image patch yields 56 ISA-transform-coefficients, which yield fourteen four-dimensional ISA-transform-coefficient vectors. Note that training on different datasets may lead slightly different ISA bases, yet the performance of the invented metric is not sensitive to such changes. Each basis is vectorized to a row vector and the fourteen bases yield a 56×64 matrix W. If each 8×8 image patch is vectorized to a column vector [symbol] , the ISA transform is given by:

[symbol]

=W

[symbol]

where [symbol] is a column vector with length of 56, consisting of the ISA-transform-coefficients. There is no reason to limit this study to the computational model of ISA.

The concepts of phase and amplitude come from the frequency-based signal representation. For example, the Fourier transform of a 1D discrete signal is given by the sum:

$$I ( x ) = {\sum }_{u = 0}^{U - 1} {A}_{u} cos ( {ω}_{u} x + {θ}_{u} ) \qquad ( 1 )$$

where ωᵤ, Aᵤ and θᵤ are respectively the frequency, amplitude and phase of the u-th harmonic component. Given frequency ωᵤ, the harmonic component can be further expanded into the weighted sum of a pair of even- and odd-symmetric bases as:

$$I ( x ) = {\sum }_{u = 0}^{U - 1} {A}_{u} cos {θ}_{u} cos ( {ω}_{u} x ) + {A}_{u} sin ( - {θ}_{u} ) sin ( {ω}_{u} x ) \qquad ( 2 )$$

where Aᵤ cos θᵤ and Aᵤ sin(−θᵤ) are the pair of weights and can be obtained by the projections of {I(x), cos(ωᵤx)} and {I(x), sin (ωᵤx)} respectively. The magnitude (amplitude) and phase of the pair of weights correspond to the (peak) amplitude and phase of the harmonic component.

Unfortunately, the Fourier transform is defined over the whole signal/spectrum of the signal and lacks spatial localization. Therefore, analysis is often performed within a narrow band of frequencies to enhance the spatial localization and to mimic the frequency-selectivity of V1 cells. Virtually, the receptive fields of simple cells are often modeled by 2D Gabor filters, since a pair of simple cells is frequently a response to a pair of even- and odd-symmetric Gabor-like stimuli respectively. The complex cell's response is well captured by the magnitudes of the responses of the pair of Gabor filters. From this point of view, the local power and phase spectra of visual stimulus are linked with the neural responses in V1.

Apart from Gabor filters, ISA (independent subspaces analysis) provides a non-redundant approximation of the receptive fields of V1. The PAP metric is based on the “phase” and “amplitude” errors of ISA transform coefficient vectors and is thereby computational concise. Learning bases from unlabeled image patches, ISA is able to learn Gabor filters with many frequencies and orientations, and to group similar bases in a group thereby achieving phase-invariance. ISA can be regarded as a two-layered network, with square and square-root nonlinear operators in the first and second layers respectively. The weights of the first-layer are learned and the weights of the second-layer are fixed. The first-layer unit simulates the receptive field of simple cells, while each of the second-layer units pools over a small neighborhood of adjacent first-layer units, to mimic complex cells.

To be precise, given an input image patch x^{k}ε [symbol] ¹ the activation of each first-layer unit is sⱼ²=Σᵢ₌₁^{l}Wⱼᵢxᵢ^{t})², and the activation of each second-layer unit is

Sₜ(x^{k}ⱼW)=\sqrt{Σⱼ₌₁^{j}s_{(t-1)·J+j}²}={square root over (Σⱼ₌₁^{J}(Σᵢ₌₁ⁱW_{(t-1)·J+j,i}x [symbol] ^{t})²)}.

W ε [symbol] ^{(J·T)×i} is the weight of the first layer. I, J and T are the input dimension (number of pixels in a patch), subspace dimension (number of the first-layer units to be pooled for a second-layer unit), and number of the subspace (number of the second-layer units) respectively. The row vectors in W, as image bases, support a linear-transformed space and further group it into subspaces. Each subspace corresponds to a second-layer unit and the involved first-layer units. ISA learns W via sparse representations in the second-layer, by equivalently solving:

$${min}_{W} {\sum }_{k = 1}^{K} {\sum }_{t = 1}^{T} {S}_{t} ( {x}^{k} , W ) , s . t . {WW}^{T} \approx I \qquad ( 3 )$$

S where {x^{k}}ₖ₌₁^{K} are input image patches which have been linearly transformed to have zero mean and identity covariance. The orthonormal constraint is to guarantee the transform W nearly invertible.

After learning W, the ISA transform can be performed and the ISA transform coefficients (ISA coefficient for short) can be obtained for each image patch. Denote the ISA transform coefficient vector (ISA vector for short) within the t-th subspace by sₜ=[s_{(t-1)·j+1}, s_{(t-1)·j+2}, . . . , s_{t·j}]T. Given a pair of reference and distorted image patches, their ISA coefficients vectors (ISA vector for short) can be computed, denoted by sₜ^{ref} and sₜ^{dis} respectively. The local magnitude (amplitude) difference (error) and local phase difference (error) between the pair of ISA vector are defined as:

$$\begin{matrix} \begin{matrix}{A}_{t} = \vert {s}_{t}^{ref} \vert - \vert {s}_{t}^{dis } \vert \\ = \sqrt{{\sum }_{j = 1}^{J} {s}_{( t - 1 ) \cdot J + {j}^{2}}^{ref}} - \sqrt{{\sum }_{j = 1}^{J} {s}_{( t - 1 ) \cdot J + {j}^{2}}^{dis}}\end{matrix} & ( 4 ) \\ \begin{matrix}{θ}_{t} = arccos \frac{〈 {s}_{t}^{ref} \cdot {s}_{r}^{dis} 〉}{\vert {s}_{t}^{ref} \vert \cdot \vert {s}_{t}^{dis} \vert} \\ = arccos \frac{{\sum }_{j = 1}^{J} ( {s}_{( t - 1 ) \cdot j + j}^{ref} \cdot {s}_{( t - 1 ) \cdot j + j}^{dis} )}{\sqrt{{\sum }_{j = 1}^{J} {s}_{( t - 2 ) \cdot j + {j}^{2}}^{ref} \cdot {\sum }_{j = 1}^{J} {s}_{( t - 1 ) \cdot \text{?} + {j}^{2}}^{dis}}} , ( 0 \leq {θ}_{t} \leq π )\end{matrix} \\ \text{?} \text{indicates text missing or illegible when filed} & ( 5 )\end{matrix}$$

Aₜ, as the amplitude error, simulates the difference of responses of complex cells; complimentarily, θₜ may be described as the phase error, which is computed from the products of responses of simple cells as shown in Equation (5). Generally, the lower case “s” represents the ISA coefficient. The bold lower case “s” represents the ISA coefficient vectors and the upper case “S” represents the second-layer unit response, i.e. the magnitude of the adjacent ISA coefficient.

Given the errors of power and phase, the local distortion is defined as:

dₜ=|Aₜ|^{α}θₜ^{β} (6)

where α and β are (usually positive) parameters. To combine the amplitude and phase error, product is chosen instead of sum. The pro and cons for using the product as opposed to the sum will be discussed below.

Images can be divided into un-overlapped patches by blocking methods or overlapped patches by a sliding window. In an exemplary embodiment, blocking methods have been chosen because blocking methods are computationally fast yet guarantee metric accuracy for typical image impairments. A sliding window may ensure more constant accuracy for other unknown image impairments. Assume there are a total of K patches for an image.

Images can be transformed to a pyramid by successive down-sampling. Assume from fine to coarse, there are 1, 2, . . . , L scales. In an exemplary embodiment, L=5. At each scale of the pyramid, an image pair can be divided into patch pairs and the local distortions can be computed.

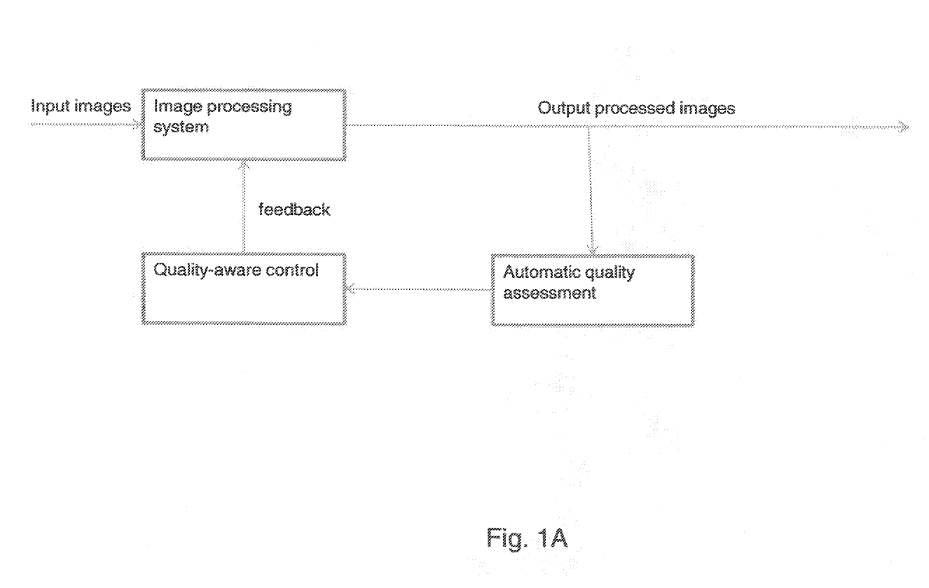

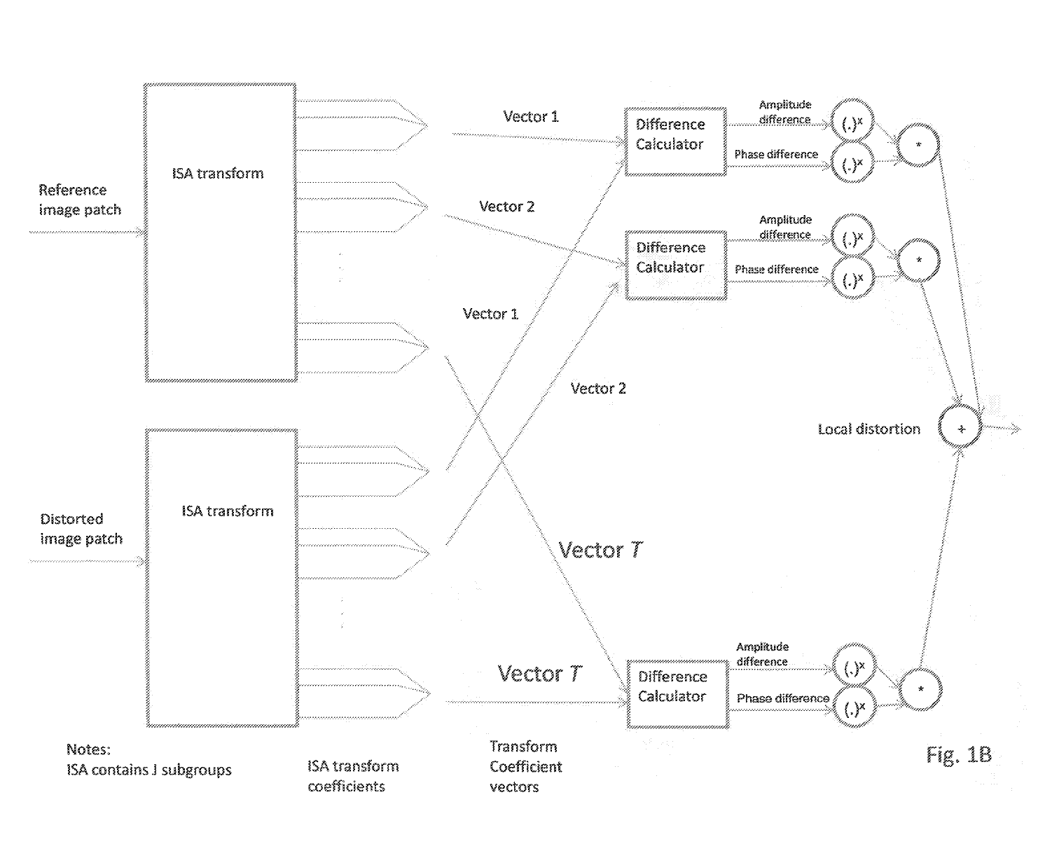

FIG. 1B is a block diagram of an exemplary embodiment of the determination of the local distortion. A reference image patch is received and the ISA transform is performed and the ISA transform coefficients are obtained for each image patch. The ISA coefficients within subspace t are denoted by vector sₜ. Given a pair of reference and distorted image patches, their ISA transform coefficient vectors are computed. The local magnitude (amplitude) difference (error) and local phase difference (error) between the pair of ISA vectors is calculated by the difference calculators (for each pair). The power function then raises the absolute value of A to the α power and raises θ to the β power, where A is the local amplitude difference for a pair of reference and distorted ISA vectors and θ is the local phase difference for a pair of reference and distorted ISA vectors. Once the power function is performed the product of the local amplitude difference and the local phase difference is obtained by the multiplier. The products are then summed by the adder to yield the local distortion.

Receptive field sizes differ among the V1 cells. Since ISA omits the diversified spatial-frequency selectivity of V1 cells, multi-scale evaluation is adopted. The global distortion at each scale is computed as:

$${D}_{l} = \frac{{γ}_{i}}{{K}_{i}} {\sum }_{k = 1}^{{K}_{l}} \text{?} {\vert {A}_{l , k , t} \vert}^{{α}_{l}} {θ}_{l , k , t}^{{β}_{i}} , for l = 1 , 2 , 3 \\ \text{?} \text{indicates text missing or illegible when filed} \qquad ( 7 )$$

where l indexes the image scale from fine to coarse and γₗ is positive weight parameter for each scale. k spatially indexes the image patches in each scale and the k-th scale contains a total of Kₗ patches. A total of three layers are found to be sufficient for predicting most types of image distortions except the distortions “mean adjustment” and “contrast enhancement” (in the TID database). These two types of impairments do not frequently occur in the applications such as coding and watermarking. The two exceptions are globally consistent distortion, so the evaluation at much coarser scale is helpful. Moreover, contrast enhancement sometimes improves the image quality despite the existence of amplitude errors. An extended mode of total distortion is required. In the extended mode, in order to measure the distortion due to contrast enhancement, the distortions at the fourth and fifth scales are defined as:

$${D}_{l} = \frac{{γ}_{l}}{{K}_{l}} {\sum }_{k , t} {d}_{l , k , t} , where \\ {d}_{l , k , t} = sign ( {A}_{l , k , t} ) {\vert {A}_{l , k , t} \vert}^{{α}_{l}} {θ}_{l , k , t}^{{β}_{l}} for l = 4 , 5 \qquad ( 8 )$$

where αₗ βₗ and γₗ are parameters for the l-th scale. The signs of A_{l,k,t} remain after the power and thus, contrast enhancement might lead to a negative global (total) distortion at the current scale.

For a best mode, the overall distortion is the sum of global distortions over the first three scales. For an extended mode, the overall distortion may be the sum of global distortions over the first five or more scales.

The overall distortions are able to ordinally match the subjective opinions on perceived image quality quite well, but not to numerically match the subjective opinions on perceived image quality. The obstacle to numerical match is that subjective opinions tend to “saturate” for very bad or good image quality, termed as flooring and ceiling effects in most psychological measurements. The flooring and ceiling effects depend on the level range of distortions in a database. The total distortion is mapped to a quality score by a sigmoid function. A sigmoid function can simulate the ceiling effect and the flooring effect in psychological measurements. A log-logistic regression is used to monotonically map the overall distortions to the output quality scores:

$$q = \frac{1}{1 + {a ( {\sum }_{i} {D}_{l} )}^{b}} \qquad ( 9 )$$

where a and b are regression parameters associated with each dataset. a is positive and thus q is normalized into the range of (0, 1]. Note that the sigmoid function will not change the ranks among the quality predictions and thus does not affect the ordinal predictions to images' quality.

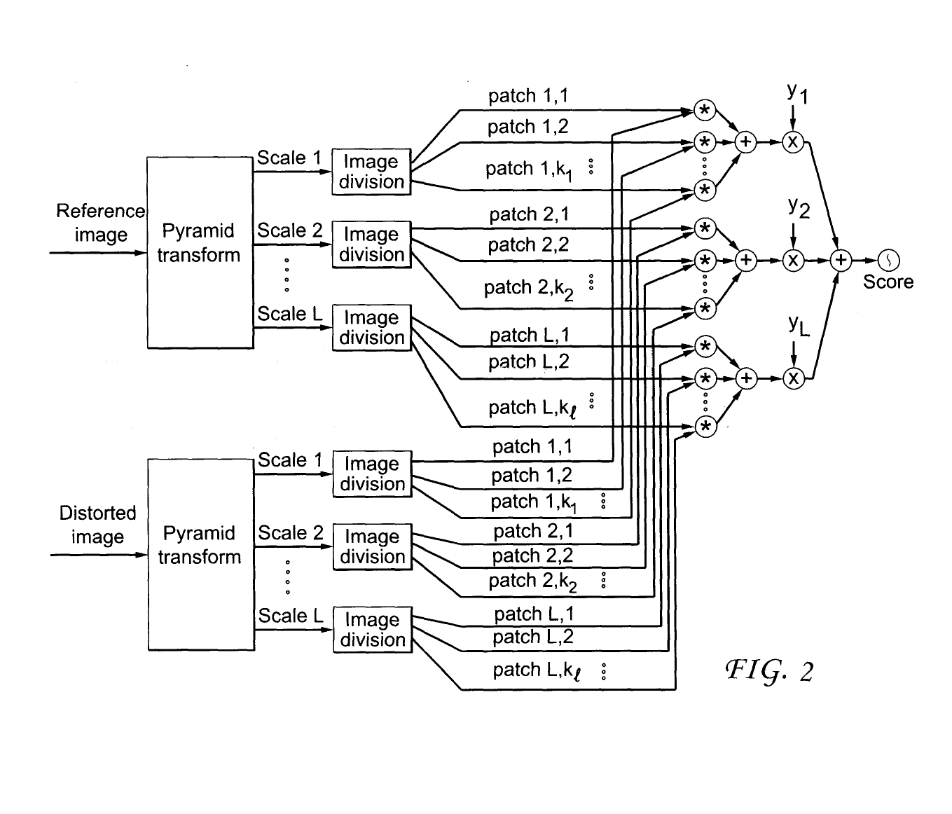

FIG. 2 is a block diagram of an exemplary embodiment of the determination of the total (global) distortion. The circle with the * symbol is the functional modular of FIG. 1B. γ₁, γ₂, . . . , γ_{L} are parameters. The score is determined by the sigmoid (log-logistic function). At the l-th scale there are a total of Kₗ patches. The reference images are input to a pyramid transform function, which outputs scales 1 to L. The scales then are input to an image division function to produce image patches. Each image division function produces image patches l, k where l varies from 1 to L and k varies from 1 to Kₗ. That is the first-layer image division function produces image patches (1,1), (1,2), . . . (1, K₁). The second layer image division function produces image patches (2,1), (2,2), . . . (2, K₂). The last/coarsest layer image division function for the reference image produces image patches (1,1), (L,2), (L, K_{L}). The distorted image is input to a pyramid transform function, which outputs scales 1 to L. The scales then are input to an image division function to produce image patches. Each image division function produces image patches l, k where l varies from 1 to L and k varies from 1 to Kₗ. That is the first image division function produces image patches (1,1), (1,2), . . . (1, K₁). The second image division function produces image patches (2,1), (2,2), . . . (2, K₂). The last image division function for the reference image produces image patches (1,1), (L,2), (L, K_{L}). Image patches (1,1) for the reference image and image patch (1,1) for the distorted image are input to the functional modular (local distortion calculation function) shown in FIG. 1B. The local distortion results for image patch pairs (l,k) are then added together (summed). The results of this operation are multiplied by the parameter for the respective γₗ parameter. The results of this multiplication are then summed and the sigmoid function applied to determine the score of the PAP metric.

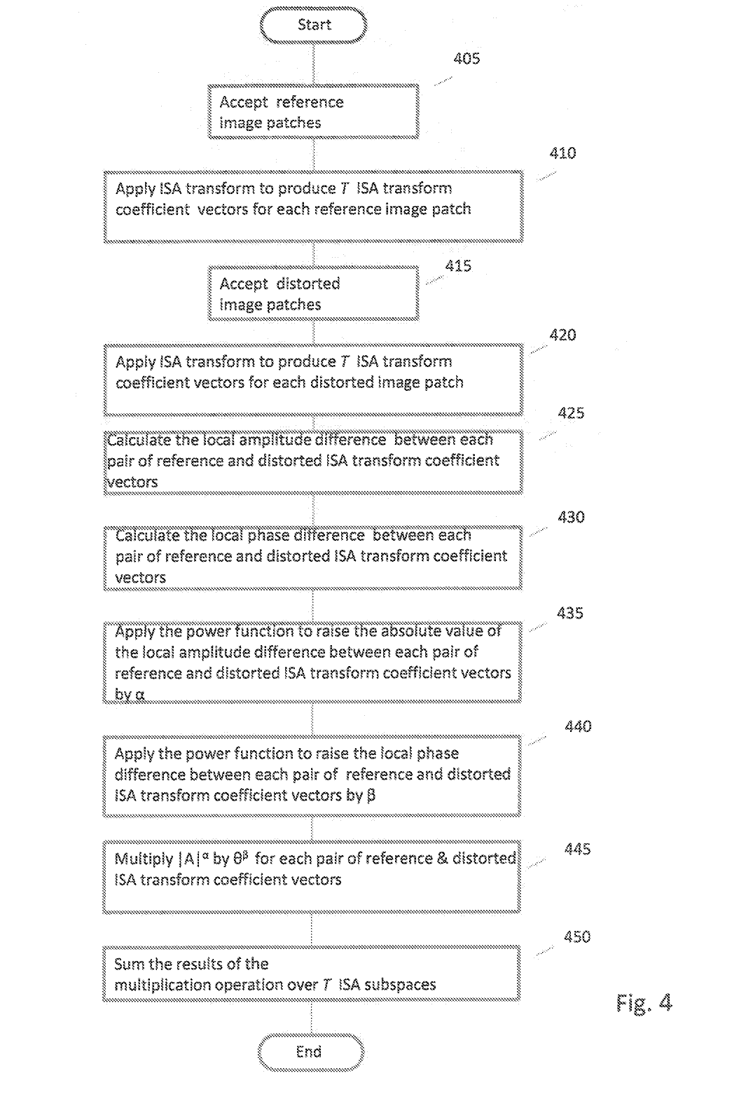

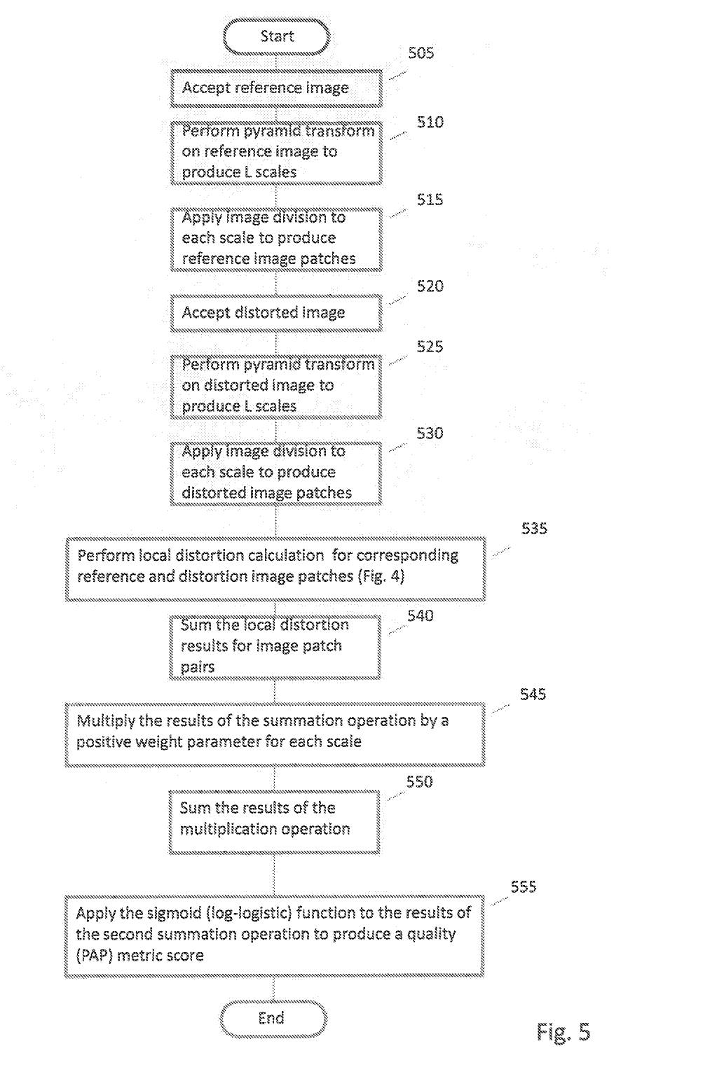

FIG. 4 is a flowchart of an exemplary embodiment of the local distortion computation of the quality metric of the present invention (PAP metric). At 405, reference image patches are accepted (input, received). At 410, the ISA transform is applied to produce a total of T ISA transform coefficient vectors for each reference image patch. At 415, distorted image patches are accepted (input, received). At 420, the ISA transform is applied to produce a total of T ISA transform coefficient vectors for each distorted image patch. At 425, the local amplitude difference between each pair of reference and distorted ISA transform coefficient vectors (ISA vector for short) is determined (calculated). At 430, the local phase difference between each pair of reference and distorted ISA vectors is determined (calculated). At 435, the power function is applied to raise the absolute value of the local amplitude difference between each pair of reference and distorted ISA vectors by α. At 440, the power function is applied to raise the local phase difference between each pair of reference and distorted ISA vectors by β. At 445, multiply |A|^{α} by θ^{β} for each pair of reference and distorted ISA vectors. At 450, the results of the multiplication operation are summed (added together) over all the T ISA subspaces.

FIG. 5 is a flowchart of an exemplary embodiment for determining the score of the quality metric of the present invention (PAP metric). At 505, a reference image is accepted (input, received). At 510, pyramid transform is performed on the reference image to produce L scales. At 515, image division is applied to each scale to produce reference image patches. At 520, a distorted image is accepted (input, received). At 525, pyramid transform is performed on the distorted image to produce L scales. At 530, image division is applied to each scale to produce distorted image patches. At 535, local distortion calculation is performed for corresponding reference and distortion image patches (see FIG. 1B and FIG. 4). At 540, the local distortion results for image patch pairs are summed (added together). At 545, the results of the summation operation are multiplied by a positive weight parameter for each scale. At 550, the results of the multiplication operation are summed (added together). At 555, the sigmoid (log-logistic) function is applied to the results of the second summation operation to produce a quality (PAP) metric score.

FIGS. 1B and 2 show the modules used by the automatic object metric module of FIG. 1A. The modules illustrated may be software, hardware or firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a special purpose image processing computer platform having hardware such as one or more central processing units (CPU), a random access memory (RAM), and input/output (I/O) interface(s). The special purpose image processing computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed.

There are two pyramid transform modules depicted one for the reference image and one for the distorted image. There may, in fact, be a single pyramid module that is reused. Similarly, there may be multiple image division modules, local distortion modules, summation modules and multiplication modules or there may a single copy of each module. The number of each type modules may be determined by the space on a circuit board or the amount of storage if the function is implemented in software. There is a single sigmoid function (log-logistic) module. With respect to the local distortion calculation module, there may be multiple ISA transform modules, multiple difference calculators, multiple power function modules and multiple multiplication modules or a single copy of each for the same reasons as indicated above.

The parameters {αₗ, βₗ, γₗ} are determined empirically offline to optimally match the predicted scores with the subjective opinions in ample subjectively-rated image quality databases, so as to guarantee the prediction accuracy for any incoming application environment. The parameters (a, b) must be adaptive to the incoming data, and will be determined online by the traditional log-logistic regression algorithm. Note that parameters (a, b) only improve the numerical prediction accuracy, but are useless for the ordinal prediction accuracy.

Specifically, a pyramid transform module is the means for accepting a reference image. The pyramid transform performs a pyramid transformation on the accepted reference image to produce a predetermined number of scales. The image division modules are applied to each scale to produce reference image patches. A pyramid transform module is the means for accepting a distorted image. The pyramid transform performs a pyramid transformation on the accepted distorted image to produce a predetermined number of scales. The image division modules are applied to each scale to produce distorted image patches. There may be a separate pyramid transform for the reference and distorted images or a single pyramid transform that is re-used. Similarly, regarding the image division modules, there may be image division modules for reference scales and for distorted image scales or a single set of image division modules may be re-used. The means for performing a local distortion calculation for corresponding reference and distorted image patches is depicted in FIG. 1B and will be discussed below and is depicted in FIG. 2 by a star within a circle. The means for summing local distortion calculation results for image patch pairs is a plurality of summation modules and is depicted in FIG. 2 as a “+” sign (symbol) within a circle. The means for multiplying results of the summation operation by a positive weight for each scale is a plurality of multiplication modules depicted in FIG. 2 as an “X” within a circle. The means for summing the results of the multiplication means is a summation module and is depicted in FIG. 2 as a single “+” sign (symbol) within a circle. The means for applying a sigmoid function to results of the second summation means to produce the quality metric score is a sigmoid function module and is depicted in FIG. 2 as a stylized integral symbol within a circle.

The local distortion calculation means is depicted in FIG. 1B. The ISA transform module is the means for accepting the reference image patches. The ISA transform module produces ISA transform coefficient vectors for each of the reference image patches. The ISA transform module is the means for accepting the distorted image patches. The ISA transform module produces ISA transform coefficient vectors for each of the distorted image patches. There may be a separate ISA transform module for the reference and distorted image patches or a single ISA transform module that is re-used. A plurality of difference calculators are the means for determining a local amplitude difference between each pair of reference and distorted ISA transform coefficient vectors as well as being the means for determining a local phase difference between each pair of reference and distorted ISA transform coefficient vectors. A power function module depicted in FIG. 1B as a set of parentheses with a dot in the parentheses and an exponent is the means for applying a power function to raise an absolute value of the local amplitude difference between each pair of reference and distorted ISA transform coefficient vectors by a first predetermined weight. The power function module is also the means for applying a power function to raise the local phase difference between each pair of reference and distorted ISA transform coefficient vectors by a second predetermined weight. The multiplication module is depicted in FIG. 1B as a “*” within a circle and is the means for multiplying results of the power function applications for each pair of reference and distorted ISA transform coefficient vectors. A summation module is depicted in FIG. 1B as a “+” sign (symbol) within a circle and is the means for summing the multiplication results.

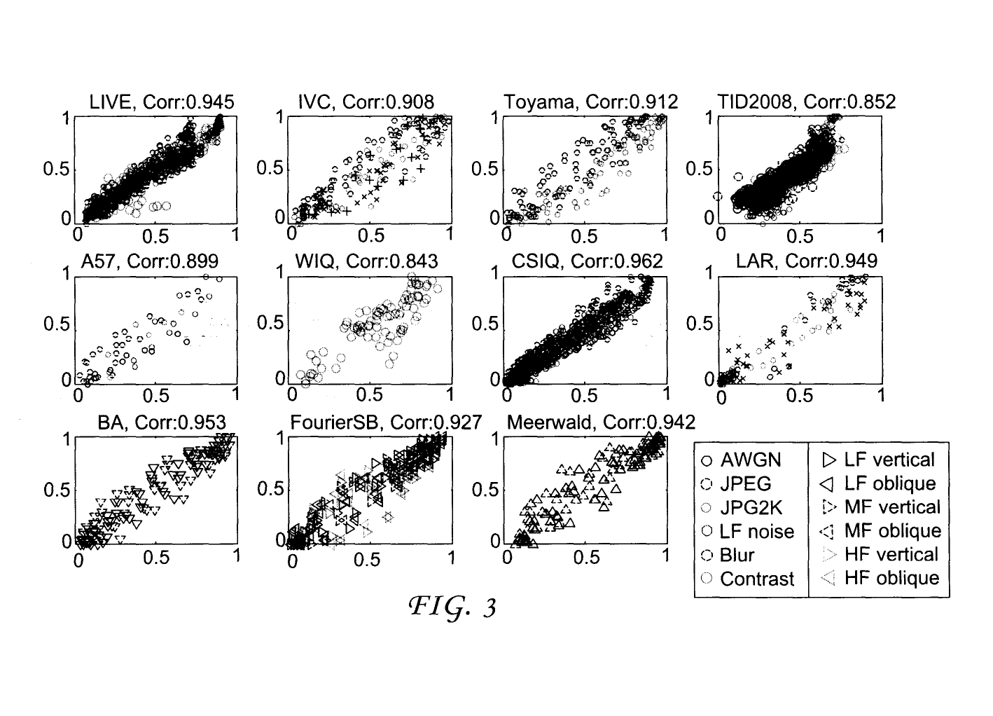

The quality metric of the present invention was tested on eleven publicly-available subjective image quality databases. The subjective DMOS (Difference Mean Opinion Score) versus the objective score are plotted in FIG. 3.

A single set of parameters {αₗ, βₗ, γₗ} (see Table 2 below) were jointly trained for all eleven databases under the maximum-likelihood criterion Equation (11) and then compared to the obtained quality metric with the state-of-the-art on the individual databases in terms of ρₛ (Spearman's Rank Order Correlation Coefficient (SROCC)) as shown in Table 1 below. ρₛ measures the ordinal match between the subjective and the predicted score sets, and is invariant with any monotonic mapping of either set. A higher ρₛ indicates a better match and ρₛ=1 indicates a perfect match. It can be found that the quality metric of the present invention outperforms MSE and CW-SSIM and achieves an accuracy comparable to FSIM.

It must be noted again that the first three layers are sufficient to measure most types of image distortions except the “mean adjustment” and the “contrast enhancement” in the TID database. Naturally, the optimized β₄ and β₅ are small, so that the amplitude error takes dominant effect for “mean adjustment” and “contrast enhancement”. Now, focusing within the first three layers, it can be concluded that: 1) the amplitude plays the most significant role at the finest scale since α₁ is the maximal in {α₁}; 2) the phase becomes more important from the fine to the coarse layer since βₗ increases with l; 3) both the amplitude and phase are necessary for image quality assessment since none of {αₗ, βₗ|l=1, 2, 3} is small enough to be neglected. It was surprising to see that {αₗ} does not follow a monotonic trend at the second scale. The inequality αₗ>α₃>α₂ holds even when {α₁, β₁, γ₁} were optimized for each individual databases. The non-monotonic trend cannot be ascribed to the diversity or inconsistency across the databases.

TABLE 1
Accuracy (ρ_{S}) of image quality metrics on subjectively-rated databases

| | DB | | | | | | | | | | |
|---|---|---|---|---|---|---|---|---|---|---|---|
| | LIVE | IVC | Toyama | TID | A57 | WIQ | CSIQ | LAR | BA | FourierSB | Meerwald |
| | Number of distortion types | | | | | | | | | | |
| | 5 | 5 | 2 | 17 | 5 | 1 | 6 | 3 | 2 | 6 | 2 |
| | Number of images | | | | | | | | | | |
| | 779 | 185 | 168 | 1700 | 54 | 80 | 886 | 120 | 120 | 210 | 120 |
| PAP | .951 | .910 | .915 | .894 | .888 | .809 | .958 | .930 | .934 | .923 | .922 |
| MSE | .856 | .679 | .613 | .553 | .570 | .817 | .806 | .819 | .934 | .696 | .891 |
| CW-SSIM | .852 | .621 | .784 | .482 | .656 | .621 | .577 | .920 | .631 | .055 | .795 |
| FSIM | .963 | .926 | .906 | .873 | .918 | .806 | .924 | .958 | .934 | .914 | .930 |
| VIF | .964 | .897 | .909 | .864 | .622 | .692 | .928 | .916 | .934 | .862 | .890 |
| Multi- | .845 | .85 | .886 | .866 | .839 | .750 | .950 | .886 | .896 | .865 | .919 |
| scale- | | | | | | | | | | | |
| SSIM | | | | | | | | | | | |

Metric parameters optimized jointly on eleven subjectively-rated databases are given below:

TABLE 2

| | Scale: l fine coarse | | | | |
|---|---|---|---|---|---|
| | 1st | 2nd | 3rd | 4th | 5th |
| ^{α}l | 2.148 | 0.598 | 1.236 | 1.606 | 1.776 |
| ^{β}l | 0.193 | 0.464 | 1.049 | 0.0027 | 0.204 |
| ^{γ}l | 1 | 1443 | 1205 | 4.658 | 8.527 |

The iso-distance map of metric Equation (6) can aid in understanding the difference between the quality metric of the present invention and traditional metrics.

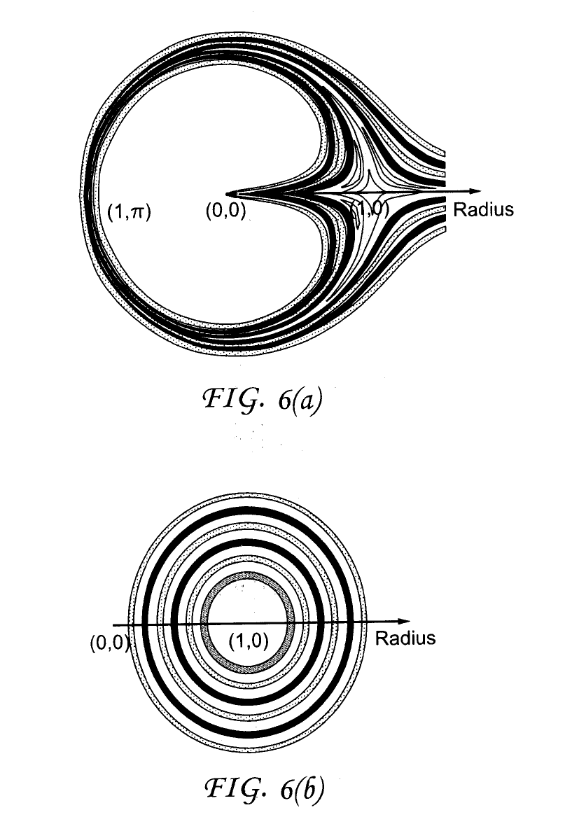

Given a reference point o and a distance d, the iso-distance curve consists of all the points which are located distance d from o. Consider a 2D polar coordinate system for simplification. Given a reference point with radius of 1 and phase angle of 0, denoted by (1, 0), its iso-distance map under metric Equation (6) is shown in FIG. 6(a). A point has a distance of zero from the reference point, as long as keeping either its phase or its amplitude the same as the reference point. This differs from the iso-distance map under MSE (mean squared error) as shown in FIG. 6(b), where a point moves farther away from the reference point unless both its phase and amplitude are equal to the reference's. Such a difference is because a product instead of a sum is employed to combine the phase and amplitude error in metric Equation (6).

This invention may also be used for particular applications like high dynamic range imaging, remote sensing, etc. Keeping in mind an accurate relationship of perceived image quality with respect to the amplitude and phase errors, it may be found, for example, a quality-aware tone mapping algorithm or a more compressive payload-balance strategy between the sensed amplitude and phase.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for determining a quality metric score for image processing, said method comprising:
accepting a reference image;
performing a pyramid transformation on said accepted reference image to produce a predetermined number of scales;
applying image division to each scale to produce reference image patches;
accepting a distorted image;
performing a pyramid transformation on said accepted distorted image to produce said predetermined number of scales;
applying image division to each scale to produce distorted image patches;
performing a local distortion calculation for corresponding reference and distorted image patches;
summing local distortion calculation results for image patch pairs;
multiplying results of said summation operation by a positive weight for each scale;
summing the results of said multiplication operation; and
applying a sigmoid function to results of said second summation operation to produce said quality metric score.

2. The method according to claim 1, wherein said local distortion calculation operation further comprises:
accepting said reference image patches;
applying an independent subspace analysis (ISA) transform to said reference image patches to produce ISA transform coefficient vectors for each of said reference image patches;
accepting said distorted image patches;
applying an independent subspace analysis (ISA) transform to said distorted image patches to produce ISA transform coefficient vectors for each of said distorted image patches;
determining a local amplitude difference between each pair of reference and distorted ISA transform coefficient vectors;
determining a local phase difference between each pair of reference and distorted ISA transform coefficient vectors;
applying a power function to raise an absolute value of said local amplitude difference between each pair of reference and distorted ISA transform coefficient vectors by a first predetermined weight;
applying a power function to raise said local phase difference between each pair of reference and distorted ISA transform coefficient vectors by a second predetermined weight;
multiplying results of said power function applications for each pair of reference and distorted ISA transform coefficient vectors; and
summing said multiplication results.

3. The method according to claim 1, wherein said predetermined number of scales is 3.

4. The method according to claim 1, wherein said predetermined number of scales is 5.

5. The method according to claim 1, wherein said positive weight is determined offline via computer training.

6. The method according to claim 2, wherein said first predetermined weight is determined offline via computer training.

7. The method according to claim 2, wherein said second predetermined weight is determined offline via computer training.

8. A system for determining a quality metric score for image processing, comprising:
means for accepting a reference image;
means for performing a pyramid transformation on said accepted reference image to produce a predetermined number of scales;
means for applying image division to each scale to produce reference image patches;
means for accepting a distorted image;
means for performing a pyramid transformation on said accepted distorted image to produce said predetermined number of scales;
means for applying image division to each scale to produce distorted image patches;
means for performing a local distortion calculation for corresponding reference and distorted image patches;
means for summing local distortion calculation results for image patch pairs;
means for multiplying results of said summation operation by a positive weight for each scale;
means for summing the results of said multiplication means; and
means for applying a sigmoid function to results of said second summation means to produce said quality metric score.

9. The system according to claim 8, wherein said local distortion calculation means further comprises:
means for accepting said reference image patches;
means for applying an independent subspace analysis (ISA) transform to said reference image patches to produce ISA transform coefficient vectors for each of said reference image patches;
means for accepting said distorted image patches;
means for applying an independent subspace analysis (ISA) transform to said distorted image patches to produce ISA transform coefficient vectors for each of said distorted image patches;
means for determining a local amplitude difference between each pair of reference and distorted ISA transform coefficient vectors;
means for determining a local phase difference between each pair of reference and distorted ISA transform coefficient vectors;
means for applying a power function to raise an absolute value of said local amplitude difference between each pair of reference and distorted ISA transform coefficient vectors by a first predetermined weight;
means for applying a power function to raise said local phase difference between each pair of reference and distorted ISA transform coefficient vectors by a second predetermined weight;
means for multiplying results of said power function applications for each pair of reference and distorted ISA transform coefficient vectors; and
means for summing said multiplication results.

10. The system according to claim 8, wherein said predetermined number of scales is 3.

11. The system according to claim 8, wherein said predetermined number of scales is 5.

12. The system according to claim 8, wherein said positive weight is determined offline via computer training.

13. The system according to claim 9, wherein said first predetermined weight is determined offline via computer training.

14. The system according to claim 9, wherein said second predetermined weight is determined offline via computer training.
